(19) United States
(12) Patent Application Publication
(10) Pub. No.: US 2009/0292982 A1
(43) Pub. Date: Nov. 26, 2009

(54) AUTOMATED PROPAGATION OF USER INTERACTION EFFECTS TO EQUIVALENT UI ARTIFACTS

(76) Inventors: Samar Choudhary, Morrisville, NC (US); Patel Niraj Dinesh, Apex, NC (US); Shikha Srivastava, Cary, NC (US)

Correspondence Address: IBM - SPP;SHIMOKAJI & ASSOCIATES, P.C., 8911 Research Drive, Irvine, CA, 92618, US

(21) Appl. No.: 12/125,662

(22) Filed: May 22, 2008

(51) Int. Cl. G06F 17/00

(52) U.S. Cl. 715/234

(57) ABSTRACT

A method for automatically propagating changes in user interaction effects across multiple user interface pages. The method includes selecting a first web based user interface page and activating a user interaction effect. Then producing a user interaction change message which is sent to a server side broker on the framework where it is queued before delivery. Then the user switches to a second web based user interface page with equivalent tasks to the first user interface page where the message may then be delivered to modify the second page to enable the action taken on the first user interface page.

### BACKGROUND OF THE INVENTION

The invention relates generally to user interface design and more particularly, to a method of transmitting user interaction or effects of user interaction across multiple equivalent user interface pages.

User interfaces are one tool which may be utilized in contemporary software applications to allow a user to interact with computer applications. In some user interface designs, a graphical model is displayed on a monitor where the user may perform, initiate, or manipulate various software functions. A user interface may allow interaction via the use of a mouse and pointer system, keyboard commands, touch screen functionality or an option to use these in combination.

Many software applications contain several pages viewable by a user and some pages may share similar elements. The page viewed by a user may contain hundreds of elements, also known as artifacts, including physical features, such as color, borders, texture, windows, tables, and toolbars. Additionally, depending on the software application and whatever page a user is currently interacting with, the page viewed may contain dozens of features coded for user enablement such as buttons, drop down menus, scroll bars, input fields and customized outputs such as graphics, music, and graphs. Some web based applications have pages that are interlinked with one another, where the pages may share the same look and feel but include different interactive content. For example, a website may include several pages with the similar borders, textures, colors, and fields displaying the website's name and a table of common links desired for display on each page. However, each page may include independent interactive features in portlets that incorporate elements such as animated graphics, input fields for sending comments, or technical run-time software tasks.

In some prior art user interface designs, during the construction phase, each page is independently built. Thus a designer may desire to insert some of the same coding between pages sharing equivalent features and tasks to maintain consistency in look, feel, and functionality. As each page is built, a designer may thus need to store coding for an element or task in a separate file and access the coding each time the element or task is desired in the first and subsequent pages. An alternative is to replicate coding by manual insertion in each page.

As can be seen, there is a need for a method of automatically propagating similar coding between pages containing equivalent features and tasks.

### SUMMARY OF THE INVENTION

A method of automatically propagating user interaction effects in a framework comprises the steps of building a collection of multiple heterogeneous web based user interface pages; selecting a first web based user interface page including a first set of user interface artifacts comprising user interaction effects selected from a group including html fragments, user interface color, table size, layout change, and user interface size; selecting a second web based user interface page including a second set of user interface artifacts equivalent to the first set and including respective user interaction effects; modifying one or more of the second set of user interface artifacts user interaction effects and producing a user interaction change message including said modifications; sending the user interaction change message to a server side broker on the framework, queuing the user interaction change message on the server side broker; switching back to the first web based user interface page; requesting the user interaction change message from the queue; relaying the user interaction change message from the server side broker to the first web based user interface page; and modifying the first set of user interface artifacts user interaction effects based on the user interaction change message to match the modifications in the second set of user interface artifacts user interaction effects.

These and other features, aspects and advantages of the present invention will become better understood with reference to the following drawings, description and claims.

### BRIEF DESCRIPTION OF THE DRAWINGS

FIG. 1 is a schematic illustration of a framework before automatic propagation according to the present invention;

FIG. 2 is a schematic illustration of the framework in FIG. 1 enabling automatic propagation according to the present invention; and

FIG. 3 a flow chart representing a series of steps involved in a method for automatically propagating user interface effects in the framework of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

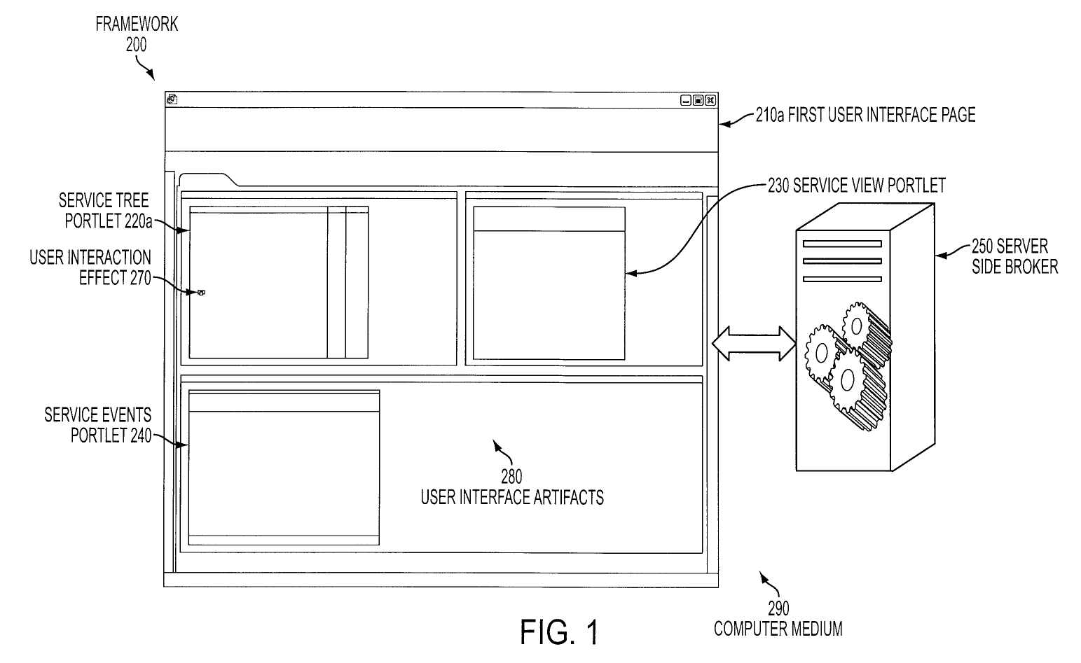

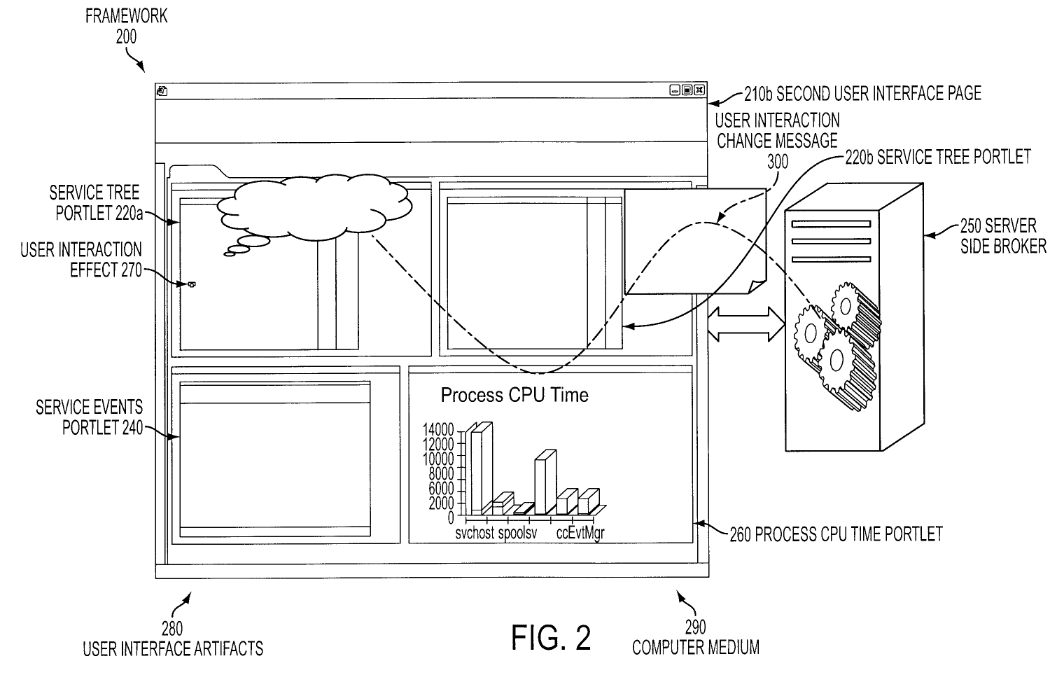

Referring to FIGS. 1 and 2, automatic propagation of user interaction effects 270 may be depicted according to one exemplary embodiment of the present invention. A framework 200 may comprise a first user interface page 210(a) built on a computer medium 290 in electronic communication with a server side broker 250. The first user interface page 210(a) (FIG. 1) may be a web based application and may include a set of user interface artifacts 280 such as a service tree portlet 220(a), a service view portlet 230, and a service events portlet 240. Each of portlets 220(a), 230, and 240 may include user interaction effects 270 for creating user interface actions on a page. A user enables a second user interface page 210(b) (FIG. 2) that may perform an equivalent task to the first user interface page 210(a). The second user interface page 210(b) may include at least one equivalent portlet to those included in the first user interface page 210(a).

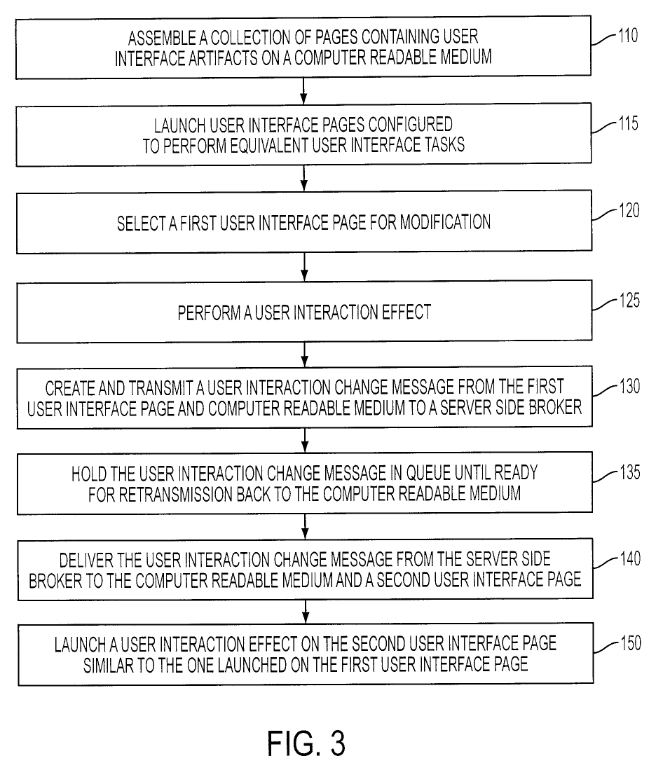

In operation, referring to FIGS. 1-3, a user may assemble a collection of pages containing user interface artifacts 280 (step 110). When a user desires to modify multiple pages automatically, the user launches user interface pages 210(a) and 210(b) configured to perform equivalent user interface tasks (step 115) and selects a first user interface page 210(a) for modification (step 120). The user may then perform or activate a user interaction effects 270 from the service tree portlet 220(a) (step 125) which may launch for example, a process CPU time portlet 260. A user interaction change message 300 can then be created and transmitted from the first user interface page 210(a) on the computer medium 290 to the server side broker 250 (step 130) where it may be held in queue until ready for retransmission back to the computer medium 290 (step 135). When the user is ready to interface with the second user interface page 210(b), the result of the user interaction 300 can be delivered from the server side broker 250 to the second user interface page 210(b) (step 140) where the message 300 directs the page to launch a portlet similar to the one launched on the first user interface page 210(a), in this exemplary case, the process CPU time portlet 260 (step 150).

While the foregoing is described in the context of two homogeneous interface pages, the asynchronous nature of the present invention permits several interface pages to also be heterogeneous and yet contain equivalent tasks. Thus, in the performance of the automatic propagation of user interaction effects it will be understood that selecting and activating a user interface artifact 280 of one page will, according to the present invention, select and activate equivalent artifacts on any of desired equivalent pages. Additionally, while the context has been described in relation to portlets such as service trees, it will be understood that other features of the user interface pages can be automatically altered across equivalent page artifacts, for example, changing the look and feel of a page, setting table row and column attributes, adding or deleting html fragments, resizing individual page fragments or portlets, and dynamic addition/deletion and resize represent use cases that are determined at runtime based on user action. Still yet, while the foregoing has been described in the context of a client side environment with the user interaction change message 300 transmitted back and forth from a server side broker 250, it will be understood that the same process may be performed in a server side environment with the message transmitted back and forth from a client side broker.

It should be understood, of course, that the foregoing relates to exemplary embodiments of the invention and that modifications may be made without departing from the spirit and scope of the invention as set forth in the following claims.

We claim:

1. A method for automatically propagating user interface effects in a framework, comprising:
building a collection of multiple heterogeneous web based user interface pages;
selecting a first web based user interface page including a first set of user interface artifacts comprising user interaction effects selected from a group including html fragments, user interface color, table size, layout change, and user interface size;
activating one or more of the first set of user interface artifacts user interaction effects and producing a user interaction change message including a result of the activated user interaction effects;
sending the user interaction change message to a server side broker on the framework;
queuing the user interaction change message on the server side broker;
switching to a second web based user interface page including a second set of user interface artifacts equivalent to the first set and including respective user interaction effects;
requesting the user interaction change message from the queue;
relaying the user interaction change message from the server side broker to the second web based user interface page; and
modifying the second set of user interface artifacts user interaction effects based on the user interaction change message to match the result of the activated user interaction effects activated in the first set of user interface artifacts user interaction effects.
